(19) United States
(12) Patent Application Publication
(10) Pub. No.: US 2007/0044341 A1
(43) Pub. Date: Mar. 1, 2007

(54) Dual path kiln

(76) Inventor: Levi A. Pollard, Appling, GA (US)

Correspondence Address: MANELLI DENISON & SELTER, 2000 M STREET NW SUITE 700, WASHINGTON, DC, 20036-3307, US

(21) Appl. No.: 11/525,929

(22) Filed: Sep. 25, 2006

Related U.S. Application Data
(63) Continuation-in-part of application No. 11/414,262, filed on May 1, 2006.
(60) Provisional application No. 60/683,859, filed on May 23, 2005.

(51) Int. Cl. F26B 25/06; F26B 7/00

(52) U.S. Cl. 34/201; 34/396

(57) ABSTRACT

An dual path kiln is provided that includes a kiln having one or more chambers and at least two lumber charge paths adapted to convey lumber through the kiln in opposite directions.

This is a Continuation-In-Part of National application Ser. No. 11/414,262 filed May 1, 2006. Embodiments of the present invention relate to the field of kilns used in the drying of lumber, and more particularly pertains to an improved kiln having a continuous opposing feed and discharge stream at each end of the kiln where the passing of the dried lumber preheats the green lumber.

### FIELD OF THE INVENTION

### Background

Drying lumber is typically performed in a batch kiln process, where an insulated chamber is used that is adapted to control several drying process conditions, including, but not limited to air temperature in the kiln, air speed across the lumber, and the relative humidity in the chamber. As these kilns are a closed atmosphere, packages of sawn lumber, often referred to as green lumber, separated by stickers are placed in the kiln in batches. The packages are often loaded vertically, horizontally, and end to end.

Once the batch of packages are in place, the chamber is closed and a schedule or recipe of temperatures and relative humidity is initiated for a determined time interval or until a certain moisture content in the lumber is achieved. Generally, the schedule gradually increases the temperature in the chamber and lowers the relative humidity. This allows the lumber to give up its moisture to the surrounding air, which may then be vented to the outside atmosphere.

The particular schedule used and the drying time varies depending on a number of factors, including, but not limited to, lumber type/species, thickness, moisture content, end use of the lumber and the like. Once the schedule has run, the kiln doors are opened and the packages are removed from the kiln chamber and further prepared for shipping to a final destination. This opens the chamber to atmospheric conditions and can often require a significant amount of time and energy to bring the next charge of green lumber up to drying conditions.

While lumber is typically dried as fast as possible depending on the cell structure, drying too rapidly can have adverse affects on the lumber, such as checking, splitting, warping, cupping, and the like. Accordingly, the temperature and humidity in the kiln, as well as the drying time will vary depending on the above listed factors. For example, Red Oak may take up to 28 days dry from green to 7% moisture content, while Southern Yellow Pine can be dried in approximately 20-24 hours from green to 15% moisture content.

### BRIEF DESCRIPTION OF THE DRAWINGS

FIG. 1 is a schematic top view of the dual path kiln of this invention;

FIG. 2 is a view similar to FIG. 1 but showing more detail;

FIG. 3 is a sectional view along lines 3-3 of FIG. 2;

FIG. 4 is a sectional view along lines 4-4 of FIG. 2; and

FIG. 5 is a side view of sections of the invention of FIG. 4.

### DESCRIPTION OF EMBODIMENTS OF THE INVENTION

In the following detailed description, reference may be made to the accompanying drawings which form a part hereof, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

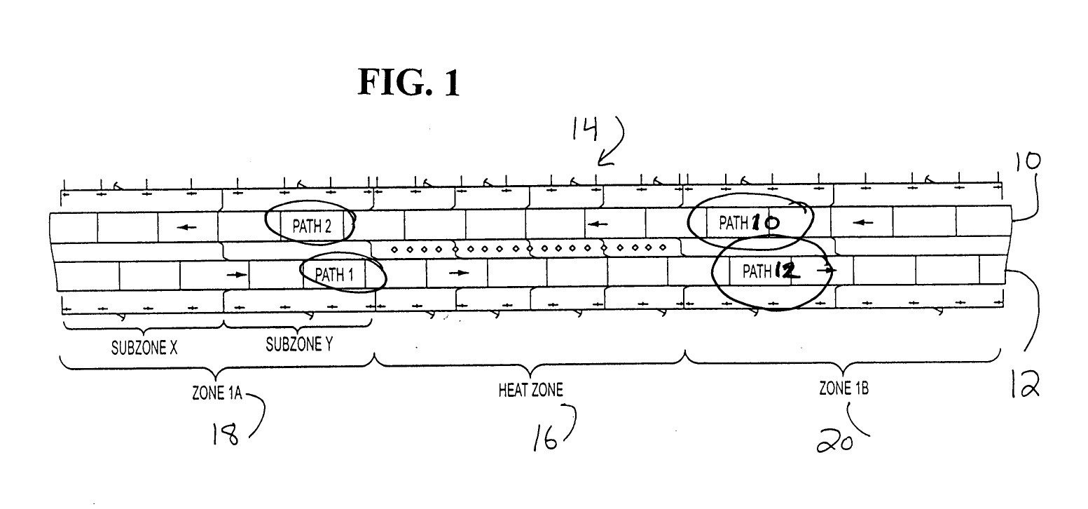

Embodiments of the present invention are directed to a continuous type lumber drying process, where, in FIG. 1, at least two different opposing paths 10 and 12 move green lumber through a kiln 14 such that a dried lumber charge exits a first end of the kiln while a green lumber charge enters the first end. Embodiments allow for the heat dissipating from the dried lumber after exiting a drying chamber to heat or preheat the green lumber, thereby saving time and energy over the batch kiln systems. Embodiments also include the green lumber releasing moisture into the air due to the heating by the dried charge, which cools the air and may assist in conditioning the dried lumber prior to exiting the kiln.

In one embodiment of the present invention, a kiln 14 may include three zones: a primary drying zone 16; and two preheat/conditioning zones 18 and 20, one being coupled to each end of the primary drying zone 16. A dual path configuration may be implemented to convey lumber through the preheat/conditioning zones 18 and 20 and the primary drying zone 16. The dual path of the present invention may convey charges in opposite directions through the kiln, and controllably operate at a rate calculated to ensure that the proper drying of a green charge is achieved from the time it enters the first end 22 and exits the second end 24 of the kiln, and when a green charge enters the second end 24 and exits from the first end 22.

By way of example, and as illustrated in the attached figures, in one embodiment in accordance with the present invention, the preheat/conditioning zones, Zone 1A,18 and Zone 1B,20, and the primary heating chamber, Heat Zone 16 may each be approximately 80 feet long, and coupled together such that a charge path 10 and a charge path 12 may pass through Zone 1A, Heat Zone and Zone 1B in a continuous manner, and in opposite directions. Embodiments of the present invention may include more than two lumber charge paths, and may further include more than three zones.

In operation, one or more of green lumber charges may be positioned to enter Zone 1A on path 12, and one or more dried lumber charges may be positioned in Zone 1A, 18 on path 10, having recently passed through the Heat Zone 16, where the charges were subjected to heated air to facilitate drying. As the green lumber charges on path 12 pass the dried lumber charges of path 10 in Zone 20, the dried charge of path 10 heats the air in Zone 1A,18. This heating effect in turn may heat the green lumber charge of path 12, thereby gradually raising the temperature encountered by the green charge and initiates the drying process of the green lumber charge. Likewise, as the green lumber charge begins to dry, it may release moisture into the air of Zone 1A, 18. This moisture release may cool the air and increase the humidity of the air. This cooler, moister air may then be circulated past the dried lumber charge of path 10 in Zone 1A,18, serving to condition the dried lumber charge exiting the kiln.

It can be appreciated that a similar preheating and conditioning process may occur in Zone 1B 20, but with the dried lumber charge being conveyed on path 12 and the green lumber charge being conveyed on path 10.

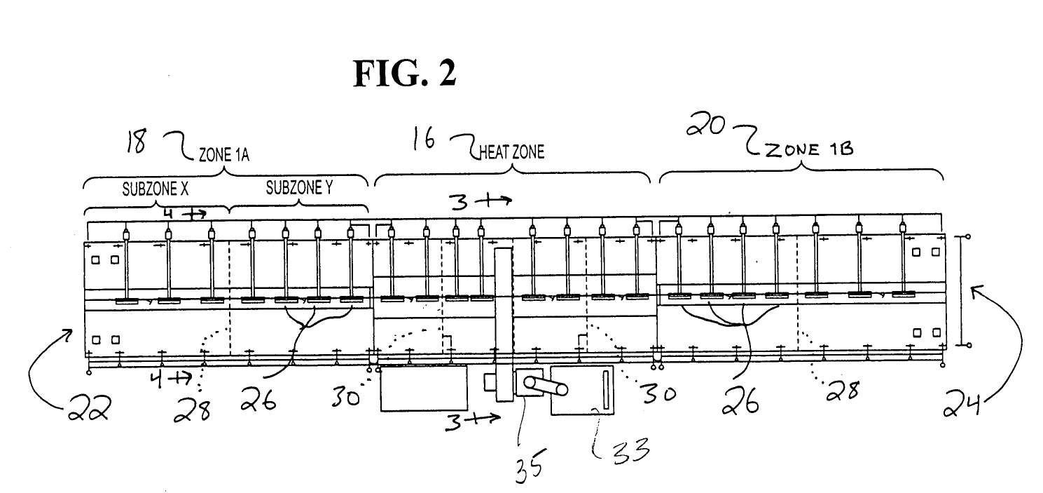

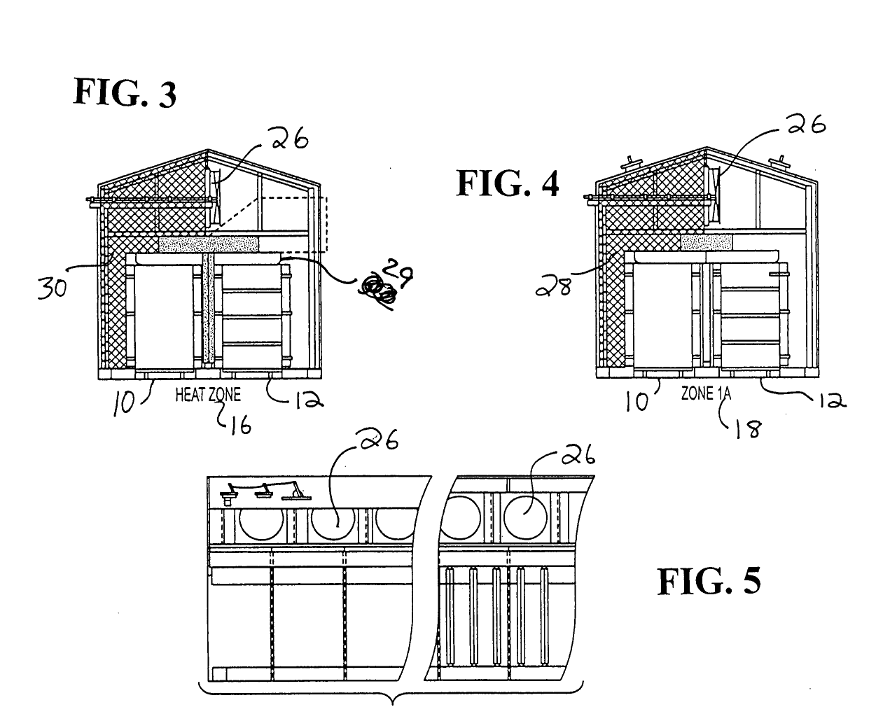

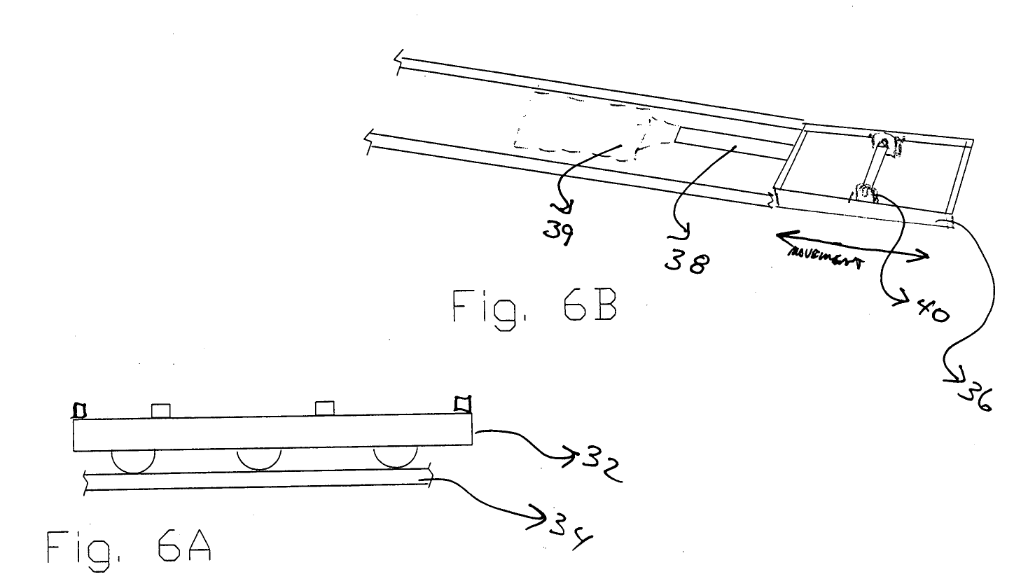

In one embodiment, fans of varying horsepower and position may be distributed in the preheat/conditioning zones to facilitate directing the movement of air between the various lumber charges. For example, fans several of which are indicated at 26 in FIGS. 2-4 may be positioned to circulate air across the dried lumber charge of path 10, and over the green lumber charge of path 12. The air may then circulate around the top and/or bottom of the charges to again be directed over the dried lumber charge of path 10, thereby effecting the heating and conditioning of the green and dry lumber charges respectively.

In one embodiment, the only venting of the kiln is through the open ends of the input/output ends 22, 24 of the preheat/conditioning zones. In other embodiments, one or more vents may be positioned in the preheat/conditioning zones to controllably regulate the temperature and manage any condensation or moisture congregation that may occur.

In one embodiment of the present invention, baffles or other partitions , as indicated in broken lines 28 in FIG. 2, may be used to not only divide the kiln heat zone from the preheat/conditioning zones, but to also further divide the interiors of the zones themselves. For example, Zone 1A, 18 may be divided into two sub-zones X and Y. Such further divisions may lead to more efficient preheating and conditioning of the lumber charges and enhance the gradual preheating and conditioning of the green and dried lumber charges respectively. Such sub-zones may also may facilitate temperature regulation within the individual heat zones and resist migration of air having a higher moisture content from moving from one sub-zone to another.

In other embodiments, the Heat zone may be multiple zones having heating elements of varying sizes to further control the gradual heating of the green lumber as it passes through the heat zones. Baffles or partitions, as indicated in broken lines 30, may also be disposed between the various heat zones to facilitate temperature regulation within the individual heat zones and resist migration of air having a higher moisture content from one heat zone to another.

In one embodiment, different horsepower/sized fans may be used in different zones or sub-zones to controllably vary the rate of air flow across the lumber charges. The baffles 28, 30 may help prevent migration of air velocity and help maintain air differentials between the zones, where different horsepower fans are being used for example. In one embodiment, the higher air velocity is generated in the zones at or near the center of the kiln. The air velocity may be gradually reduced in the zones towards the entry/discharge ends of the kiln.

In various embodiments, the travel time of the lumber charges may vary depending on many of the same factors affecting the batch kiln process. When using a continuous drying process in accordance with embodiments of the present invention, it is anticipated that the length of time for a charge to pass through the kiln and be dried to a desired moisture content will take no longer than the typical batch kiln process for analogous species and dimensions. It is preferred that the rates the charges pass through the kiln are equal but opposite in direction. The rate, however, may be varied collectively or independently depending on the rate of drying for a particular charge. Accordingly, in one embodiment, the moisture content of the lumber charges being dried is monitored, and the flow rate may be altered as needed to ensure the dried lumber charges exits the kiln at the proper moisture content.

In one embodiment, for example, when drying Southern Yellow Pine, the rate of movement of the lumber charges through the kiln may be equal on path 10 and path 12, and may be in the range of approximately 0.05-0.5 ft/min, and utilize a heating element having a rating in the range of 15-35 million BTU/hr. Again, the rate and heat source may vary depending on the factors identified above.

The overall throughput may be greater in a kiln in accordance with embodiments of the present invention, as the charges are continuously being processed as opposed to the batch kilns where once a drying cycle is complete, the charges must be removed and new charges loaded. Throughput will also be greater than a traditional kiln with the same size heat system, due to the use of heat from a dried lumber charge to heat the green lumber charge. This may further lead to reduced energy use, as the preheating of the green charges prior to entry into the primary heating chamber, or heat zone, can reduce the size or output of the heat source, for example. Further efficiency may be realized as the heat zone does not need to be cooled to the outside temperature every time a drying cycle is complete and a new charge must be loaded. Further, kilns in accordance with embodiments of the present invention may run at a constant dry bulb and relative humidity, which simplifies the various process controls.

In addition to the discussion of various embodiments above, figures and additional discussion are presented herein to further describe certain aspects and various embodiments of the present invention. It is to be understood, however, that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein.

What is claimed is:

1. A method of heat treating lumber using an elongated kiln chamber having at least two zones including a heating zone and a heat transfer zone with said zones being adjacent and each including two paths of travel for separate lumber charges, comprising the steps of feeding one charge of lumber through the heating zone at a selected speed while feeding another charge of lumber through the heat transfer zone, selecting the speed of movement of each charge so that, in the heat transfer zone, at least a portion of the heat carried by said one charge of lumber will be transferred to said another charge before said another charge enters the heating zone.

2. The method as claimed in claim 1 including wherein said elongated chamber has opposite ends with the heating zone located between two heat transfer zones each located at a said opposite end of said chamber and including the step of feeding one charge of lumber to one end of said elongated chamber and said another charge to the other of said opposite ends.

3. The method as claimed in claim 1 wherein said chamber includes fans and including the step of operating said fans to control the heat transfer in said heat transfer zones so that a portion of the heat in a said charge of lumber leaving said heating zone is transferred to the said another charge of lumber upon entering a said heat transfer zone.

4. The method as claimed in claim 1 wherein said chamber has two paths of travel through the chamber and including the step of moving the charges of lumber along said two paths with one charge being moved in one direction and the other charge being moved in a direction opposite to said one direction.

5. An apparatus for treating lumber comprising an elongated chamber having an upper wall and side walls depending from said upper wall and surrounding a heating zone having opposite ends and a first and second heat transfer zone with said heat transfer zones being located at a said end of said heating zone, each of said zones having first and second paths for moving charges of lumber along said paths in opposite directions so that a charge of lumber entering one of ends of said chamber will pass through said first heat transfer zone and then through said heating zone and then through said second heat transfer zone to transfer heat to a charge of lumber entering said second heat transfer zone.

6. The apparatus as claimed in claim 5 wherein fans are provided to move heated air through said zones to transfer a portion of the heat from a charge of lumber leaving said heating zone to a charge of lumber entering a heat transfer zone.

7. The apparatus as claimed in claim 6 wherein said fans are mounted adjacent said upper wall.

8. The apparatus as claimed in claim 5 wherein said first and second paths extend parallel to one another.

9. The apparatus as claimed in claim 8 wherein said paths are separated by a wall along at least a portion of said paths.

10. The apparatus as claimed in claim 5 wherein said paths are separated by a wall along at least a portion of said paths.

11. The apparatus as claimed in claim 5 wherein said chamber includes a floor and a conveyor apparatus is carried on said floor for moving the charges lumber through said zones.

12. The apparatus as claimed in claim 11 wherein said conveyor apparatus includes a pair of rails and carts having wheels supported on said rails.

13. The apparatus as claimed in claim 12 wherein a pusher device is provided at an end of the rails to move the carts along the rails into and through the zones in said apparatus.
